(19) United States
(12) Patent Application Publication
(10) Pub. No.: US 2026/0197427 A1
(43) Pub. Date: Jul. 9, 2026

(54) DISPLAY SYSTEM, CALIBRATION METHOD, AND COMPUTER PROGRAM

(71) Applicant: Panasonic Projector & Display Corporation, Osaka (JP)

(72) Inventors: Kazune HAGINO, Tokyo (JP); Kazuaki Sakata, Osaka (JP)

(21) Appl. No.: 19/560,462

(22) Filed: Mar. 9, 2026

Related U.S. Application Data
(63) Continuation of application No. PCT/JP2024/031605, filed on Sep. 3, 2024.

(30) Foreign Application Priority Data
Sep. 11, 2023 (JP) 2023-147031

(51) Int. Cl. H04N 9/31

(52) U.S. Cl. CPC H04N 9/3182; H04N 9/3194

(57) ABSTRACT

A calibration method of a display executed by a display system including a display, an imaging device, and an information processing device, including an arithmetic circuit. In the calibration method, the arithmetic circuit: acquires a first captured image in a state in which no image is displayed by the display from the imaging device at the timing of initial calibration; acquires a second captured image in a state in which no image is displayed by the display from the imaging device at the timing of recalibration after the initial calibration; compares the first captured image with the second captured image; detects, as a result of the comparison, an area where a difference in luminance is a predetermined value or more, with an influence of an environment change; and when the environment change is detected, outputs a notification that the environment change has occurred.

### CROSS-REFERENCE TO RELATED APPLICATIONS

This is a continuation application of International Application No. PCT/JP2024/031605, with an international filing date of September 3, 2024, which claims priority of Japanese Patent Application No. 2023-147031 filed on September 11, 2023, each of the content of which is incorporated herein by reference.

### TECHNICAL FIELD

The present disclosure relates to a display system, a calibration method, and a computer program for calibrating a display that displays a video.

### BACKGROUND ART

When a video is displayed on the display, calibration processing may be performed on the display. For example, the display is provided with the timing of initial calibration at the start of use. In addition, in response to a change with time, the display may be provided with the timing of recalibration after the start of use. In the calibration processing of the display, there is a method in which the video displayed by the display is captured by the imaging device and the captured image is used (for example, JP 2004-158941 A and JP 2011-257609 A, and the like).

### SUMMARY

Meanwhile, the video displayed by the display represented by the captured image of the imaging device may be affected by the environment in which the display exists. For example, the ambient light may differ from the timing of initial calibration to the timing of recalibration. Furthermore, for example, when the imaging device is a projector, a part of the screen on which the video is projected may be contaminated. Due to the occurrence of such an environment change, the calibration processing of the display may not be accurately performed.

The present disclosure provides a display system, a calibration method, and a computer program that accurately calibrate a display that displays a video regardless of an environment change.

The present disclosure relates to a calibration method of a display, executed by a display system, the display system including a display, an imaging device, and an information processing device, wherein the display configured to display an image, wherein the imaging device configured to capture a range in which the image is displayed by the display, wherein the information processing device configured to calibrate the display on the basis of a captured image captured by the imaging device and having an arithmetic circuit. The calibration method comprising, by the arithmetic circuit may: acquiring a first captured image in a state in which no image is displayed by the display from the imaging device at the timing of initial calibration; acquiring a second captured image in a state in which no image is displayed by the display from the imaging device at the timing of recalibration after the initial calibration; comparing the first captured image with the second captured image; detecting, as a result of the comparison, an area where a difference in luminance is a predetermined value or more, with an influence of an environment change; and when the environment change is detected, outputting a notification that the environment change has occurred.

Such a general and specific aspect may be implemented by a system, a method, and a computer program, and a combination thereof.

The display system, the calibration method, and the computer program of the present disclosure can cope with a case where the environment changes during the period from the initial calibration to the recalibration in the calibration of the display that displays the video.

### BRIEF DESCRIPTION OF DRAWINGS

FIG. 1A is a block diagram illustrating a configuration of a display system and a control device according to the present disclosure;

FIG. 1B is a block diagram illustrating a configuration of a projector adjusted by the display system in FIG. 1A;

FIG. 1C is a block diagram illustrating a configuration of a camera used in the display system of FIG. 1A;

FIG. 1D is a block diagram illustrating a configuration of a user terminal used in the display system in FIG. 1A;

FIG. 2A illustrates an example of a first captured image;

FIG. 2B illustrates an example of a second captured image;

FIG. 2C illustrates an example in which a marker indicating an area where an environment change is detected is superimposed on the second captured image;

FIG. 3A is a flowchart illustrating an example of a calibration processing of geometric distortion at the timing of initial calibration;

FIG. 3B is a flowchart illustrating an example of calibration processing of geometric distortion and/or positional deviation at the timing of recalibration;

FIG. 4A is a flowchart illustrating an example of processing of calibration of color and/or calibration of focus at the timing of initial calibration;

FIG. 4B is a flowchart illustrating an example of processing of calibration of color and/or calibration of focus at the timing of recalibration;

FIG. 5 is a flowchart illustrating an example of calibration processing of color unevenness at the timing of recalibration;

FIG. 6A illustrates an example of a screen used in a display system according to a modification;

FIG. 6B illustrates another example of the screen used in the display system according to the modification;

FIG. 7A is a flowchart illustrating an example of a calibration processing of positional deviation at the timing of initial calibration executed by a control device according to First Modification;

FIG. 7B is a flowchart illustrating an example of calibration processing of positional deviation at the timing of recalibration executed by the control device according to First Modification;

FIG. 8A illustrates an example of a relationship among a screen, a projectable range of a projector, and a capturable range of a camera;

FIG. 8B illustrates an example of a relationship between a screen and a projectable range of a projector at the time of initial calibration;

FIG. 8C illustrates an example of a relationship between a screen and a projectable range of a projector when positional deviation occurs;

FIG. 9 is a flowchart illustrating an example of calibration processing of geometric distortion at the timing of initial calibration executed by a control device according to Second Modification;

FIG. 10 is an example of an operation screen used for accepting a monitoring area in a display system according to Second Modification; and

FIG. 11 is a flowchart illustrating an example of calibration processing of geometric distortion and/or positional deviation at the timing of recalibration executed by the control device according to Second Modification.

### DETAILED DESCRIPTION

Hereinafter, embodiments of the present disclosure will be described with reference to the drawings. However, in the detailed description, unnecessary parts in the description of the conventional technique and the substantially same configuration may be omitted. This is to simplify the description. In addition, the following description and the accompanying drawings are disclosed so that those skilled in the art can fully understand the present disclosure, and are not intended to limit the subject matter of the claims.

A display system, a calibration method, and a computer program according to the present disclosure enable calibration according to an environment change in which a display is disposed when the environment changes. Hereinafter, an example in which the display is a projector that projects a video on a screen will be described. The environment change is, for example, a change in ambient light or occurrence of contamination such as stains on a screen on which a projector projects a video. In a case where the projector is installed indoors, the change in the ambient light may be a change in turning on or off of the lighting, a change in the type of lighting to be used, or the like. Furthermore, in a case where the projector is installed outdoors, the change in the ambient light may be a change in sunlight, a change in a street lamp, or the like.

In the present disclosure, “calibration” includes “calibration of positional deviation”, “calibration of geometric distortion”, “calibration of focus”, “calibration of color”, “calibration of color unevenness”, and the like. In the following description, the calibration includes initial calibration and recalibration. The initial calibration is performed at the timing of start of the use of the projector. Furthermore, recalibration is executed at any timing at which a temporal change is considered to have occurred after the start of use of the projector. For example, recalibration may be performed at regular timing after execution of the initial calibration. The periodic timing may be a timing of every day, every week, every month, or the like.

"Calibration of positional deviation" is adjustment for projecting a video accurately in accordance with a specified position of the screen when the video is projected on the screen by the projector. In the present disclosure, for example, an algorithm described in JP 2018-207373 A can be used as an algorithm for calibration of positional deviation. Further, the calibration of positional deviation may include a part of the calibration of geometric distortion.

"Calibration of geometric distortion" refers to an adjustment related to geometric distortion when projected from a projector onto a screen. For example, the calibration of geometric distortion is adjustment for displaying the image as a quadrangular image in a case where the image that should be a quadrangle is projected in a trapezoidal shape on the projection surface (trapezoidal distortion), in a case where the central portion is displayed to bulge (barrel distortion), and in a case where the central portion is displayed to contract (pincushion distortion). For example, calibration of geometric distortion is realized by adjusting a parameter value by the projector.

The "calibration of focus" is focus adjustment when a video is projected on the screen by the projector. For example, the calibration of focus is realized by adjusting a parameter value by the projector.

The "calibration of color" is adjustment in which, when a plurality of images projected by a plurality of projectors are arranged to form one image, adjacent images projected by different projectors appear to have a uniform color. Therefore, calibration of color is performed when a plurality of projectors is used. When only one projector is used, calibration of color is not performed.

The "calibration of color unevenness" is adjustment to make the entire displayed image look uniform in color when the image projected by the projector is an image represented by one color as a whole. The calibration of color unevenness is realized by adjusting the parameter value by the projector.

### Embodiment

### Configuration of Display System

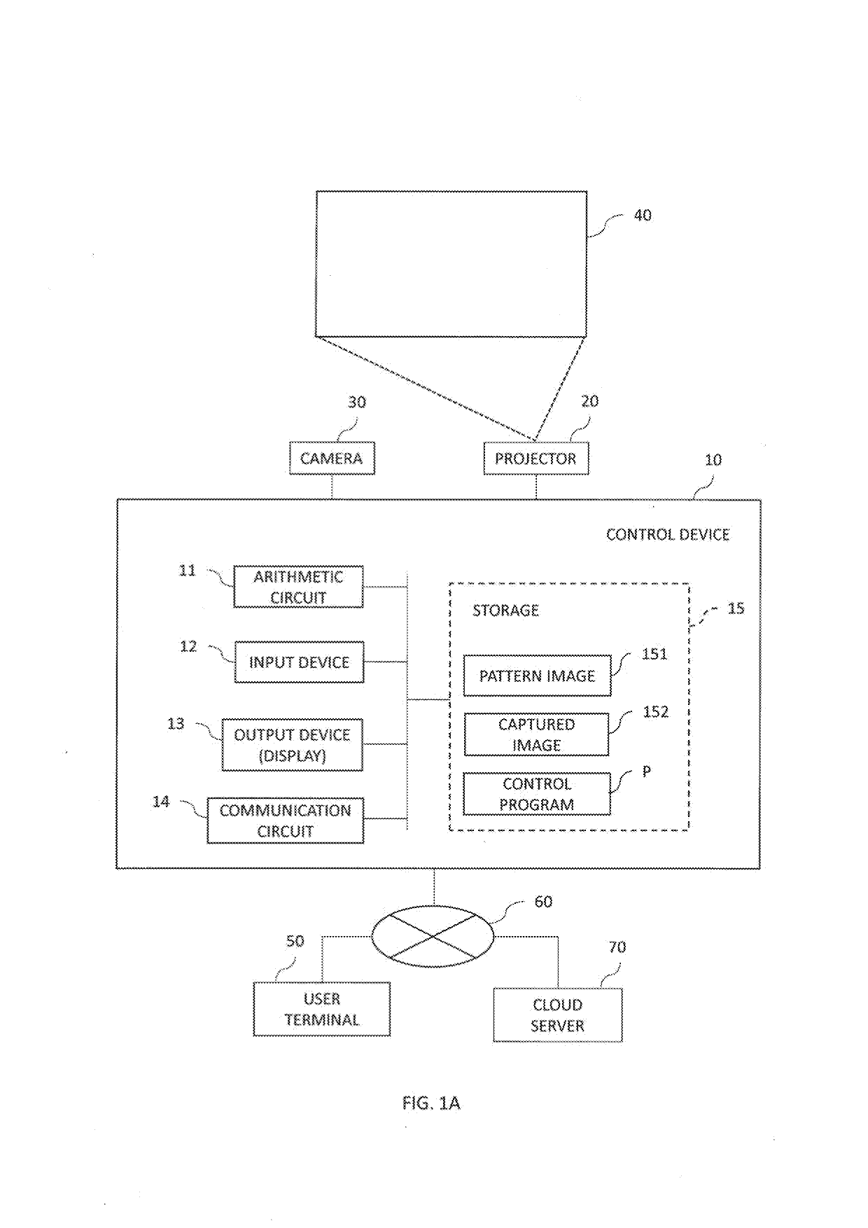

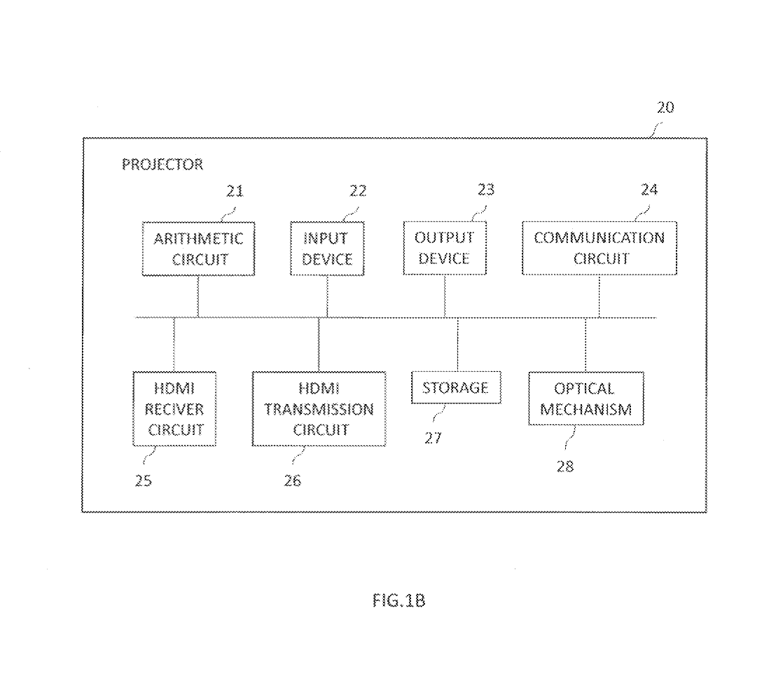

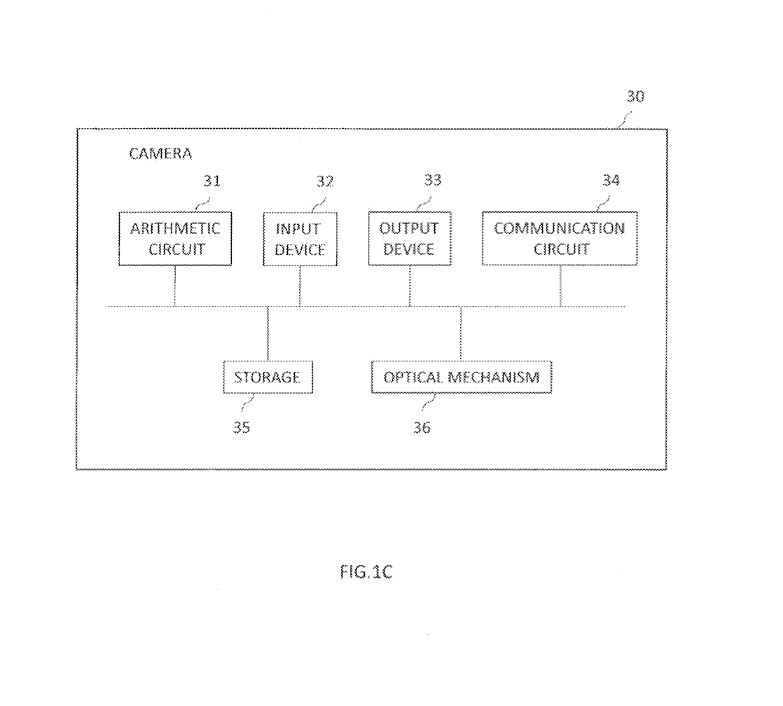

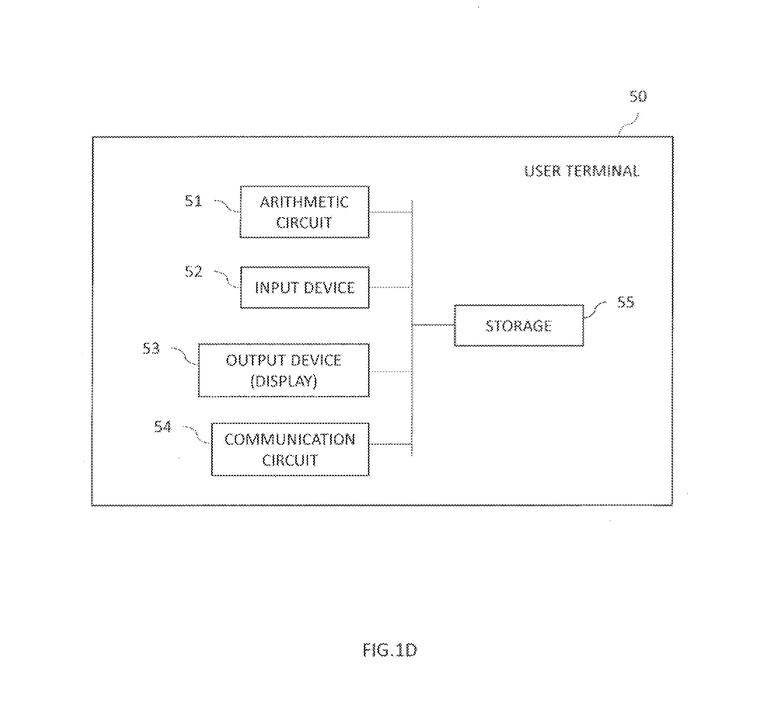

FIG. 1A illustrates an example of a display system 1 according to a first embodiment. As illustrated in FIG. 1A, the display system 1 includes the control device 10, the user terminal 50, one or more projectors 20, and one or more cameras 30. The control device 10 and the user terminal 50 are connected via a network 60 so as to be able to perform data communication. The control device 10 controls the projector 20 to project a video on the screen 40. Further, the control device 10 controls the camera 30 to capture an image of the screen 40 on which the video is projected. The control device 10 calibrates the projector 20 according to an image captured by the camera 30. At this time, the presence or absence of an environment change is detected, and a method of calibrating the projector is determined. Furthermore, the control device 10 may be connected to the cloud server 70.

### Configuration of Control Device

As illustrated in FIG. 1A, the control device 10 is an information processing device including an arithmetic circuit 11, an input device 12, an output device 13, a communication circuit 14, a storage 15, and the like. For example, the control device 10 may be a personal computer.

The arithmetic circuit 11 is a controller that controls the entire control device 10. For example, the arithmetic circuit 11 reads and executes the control program P stored in the storage 15, thereby implementing various processes related to calibration of the projector 20. The arithmetic circuit 11 may be various processors such as a CPU, an MPU, a GPU, an FPGA, a DSP, and an ASIC, or may be a dedicated hardware circuit.

The input device 12 is used for operation by the user and input of data. The input device 12 may be, for example, an operation button, a keyboard, a mouse, a touch panel, a microphone, or the like. The output device 13 is used to output processing results and data. The output device 13 can be, for example, an output means such as a display or a speaker.

The communication circuit 14 performs data communication with the projector 20 and the camera 30. The data communication is performed in a wired and/or wireless manner, for example, according to a known communication standard. For example, wired data communication may be performed by using, as the communication circuit 14, a communication controller of a semiconductor integrated circuit that operates in conformity with the Ethernet (registered trademark) standard and/or the USB (registered trademark) standard. In addition, wireless data communication may be performed by using, as the communication circuit 14, a communication controller of a semiconductor integrated circuit that operates in accordance with IEEE802.11 standards related to a wireless local area network (LAN) and/or so-called 4G/5G/6G related to mobile communication, such as a fourth/fifth/sixth generation mobile communication system.

The storage 15 is a recording medium that records various types of information. The storage 15 is realized by, for example, a RAM, a ROM, a flash memory, a solid state drive (SSD), a hard disk drive, other storages, or an appropriate combination thereof. The storage 15 can store, for example, a control program P, a pattern image 151, a captured image 152, and the like.

The pattern image 151 is used in processing related to calibration of the projector 20. The pattern image 151 includes a first pattern image, a second pattern image, and a third pattern image. The first pattern image is used at the timing of initial calibration. Furthermore, the first pattern image is used, for example, in a case where the first pattern image is not subjected to an environment change at the timing of recalibration. The second pattern image is used, for example, in a case where the second pattern image is subjected to a change in light of the environment at the timing of recalibration. The third pattern image is used at timings of calibration of color and calibration of focus.

The first pattern image includes a plurality of feature points. The first pattern image includes a plurality of areas specified by the plurality of feature points. For example, the first pattern image may be an image including a plurality of areas of red, green, blue, cyan, yellow, magenta, white, and black as described in JP 2018-207373 A. The first pattern image represents a plurality of feature points by a single image.

The second pattern image includes a plurality of feature points. The second pattern image includes a plurality of areas specified by the plurality of feature points. For example, the second pattern image includes a plurality of sets of binary pattern images of white and black as described in Japanese Patent Application Laid-Open No. 2020-160352. In other words, the second pattern image is generated such that a pattern image of a plurality of colors such as the first pattern image is divided into RGB components and expressed in binary. Therefore, even in the case of representing the same feature point, a plurality of pattern images is required, and the processing using the second pattern image becomes complicated.

The third pattern image includes a plurality of images used for calibration of color and a plurality of images used for calibration of focus. Specifically, the plurality of images used for calibration of color are monochrome color pattern images of red, green, blue, cyan, yellow, magenta, white, and black. Furthermore, the pattern image used for calibration of focus can be, for example, a white cross hatch pattern (pattern of a pattern in which a plurality of white lines intersects vertically and horizontally).

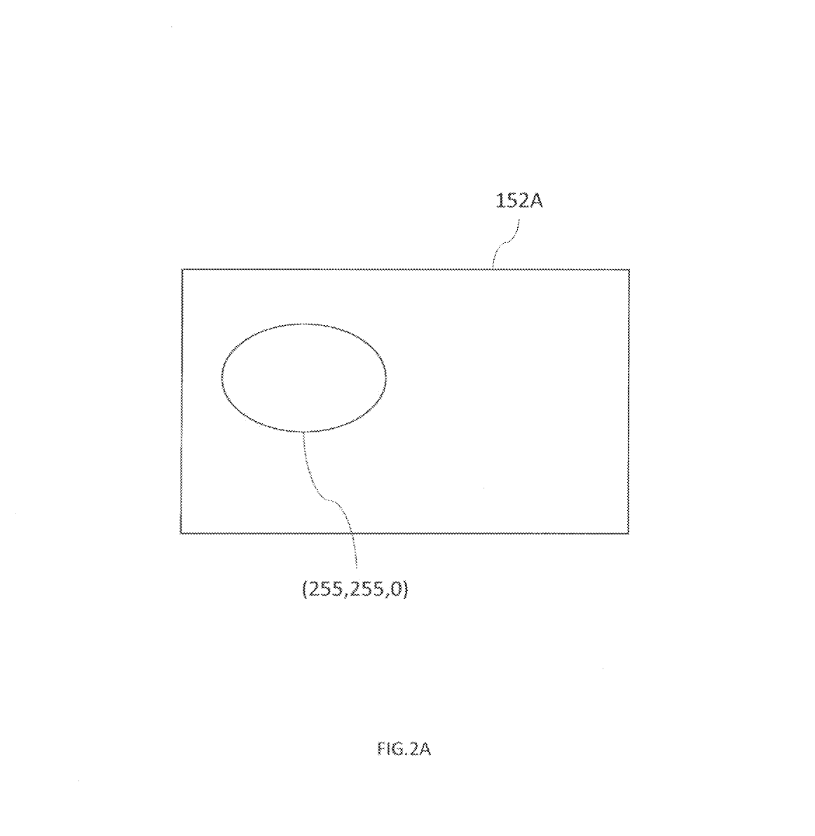

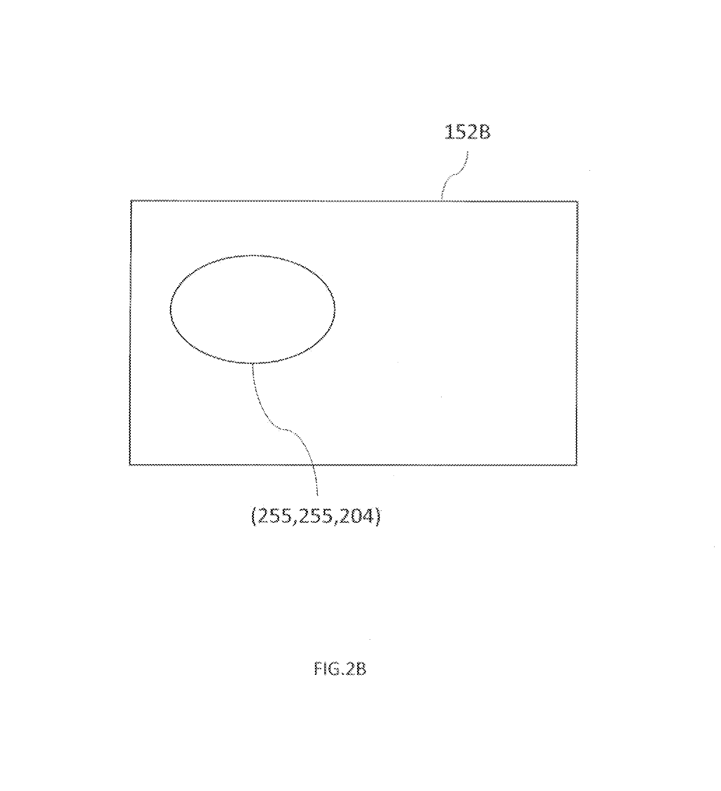

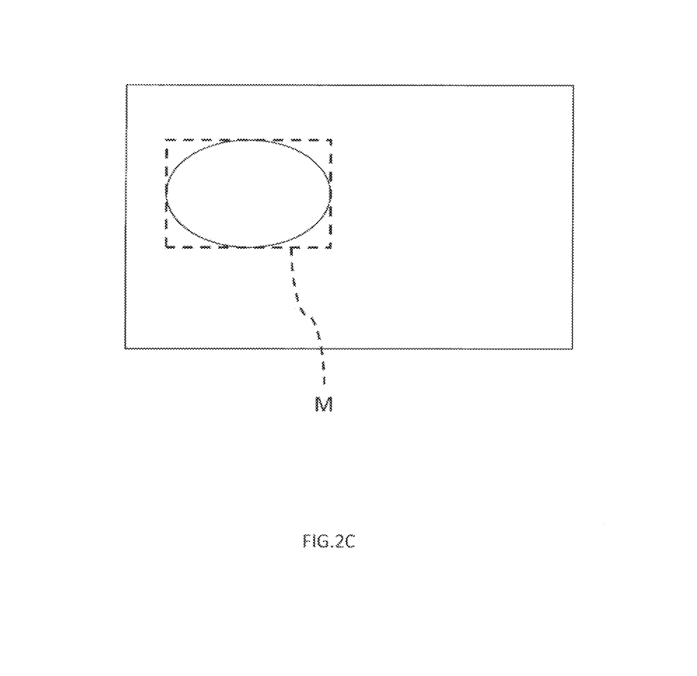

The captured image 152 is an image captured by the camera 30. For example, at the time of initial calibration, the control device 10 acquires an image captured in a state where no video is projected on the screen 40 from the camera 30, and stores the image in the storage 15 as the first captured image 152A. FIG. 2A illustrates an example of the first captured image 152A. In addition, at the time of recalibration, the control device 10 acquires an image captured in a state where no video is projected on the screen 40 from the camera 30, and stores the image in the storage 15 as the second captured image 152B. FIG. 2B illustrates an example of the second captured image 152B.

As illustrated in FIG. 2A, it is assumed that, in the first captured image 152A acquired at the time of initial calibration, a pixel value (R, G, B) in an ellipse is (255, 255, 204). In addition, as illustrated in FIG. 2B, in the second captured image 152B acquired at the time of recalibration, the pixel value (R, G, B) in the ellipse is assumed to be (255, 255, 204). In this case, the arithmetic circuit 11 detects, for example, that a portion indicated by an ellipse has undergone an environment change. In addition, as illustrated in FIG. 2C, the arithmetic circuit 11 generates and outputs a notification in which a marker M such as a broken line is superimposed on the second captured image.

The shape of the marker M is not limited to the state illustrated in FIG. 2C. Furthermore, in the example illustrated in FIG. 2C, the area subjected to the environment change is a part of the captured image 152. If the entire captured image 152 is subjected to an environment change, a notification on which the marker M indicating the entire area of the second captured image 152B is superimposed may be generated.

In the example illustrated in FIG. 1A, the control device 10 is illustrated as being realized by one device, but is not limited thereto. For example, the control device 10 may include a plurality of information processing devices. Furthermore, the control device 10 may store information in an external storage (not illustrated), and read and use the information as necessary.

### Configuration of Projector

FIG. 1B is a block diagram illustrating a configuration of the projector 20. As illustrated in FIG. 1B, the projector 20 includes an arithmetic circuit 21, an input device 22, an output device 23, a communication circuit 24, an HDMI (registered trademark) receiver circuit 25, an HDMI transmission circuit 26, a storage 27, an optical mechanism 28, and the like. The arithmetic circuit 21, the input device 22, the output device 23, the communication circuit 24, and the storage 27 can be realized by specific means similar to the arithmetic circuit 11, the input device 12, the output device 13, the communication circuit 14, and the storage 15 described above with reference to FIG. 1A. The HDMI receiver circuit 25 enables reception of data from an external device (not illustrated). Furthermore, the HDMI transmission circuit 26 enables transmission of data to an external device (not illustrated). The display 20A can communicate a video signal and an audio signal with an external device using the HDMI receiver circuit 25 and the HDMI transmission circuit 26. The display 20A includes optical mechanism 28 that projects a video. The optical mechanism 28 includes a light source such as a laser diode, an LED, or a lamp. In addition, the optical mechanism 28 includes an optical unit including a liquid crystal element that modulates light emitted from a light source, a light modulation element such as a digital mirror device (DMD), and a projection lens system that guides video light modulated by the light modulation element to a projection surface.

In the example illustrated in FIG. 1A, the display system 1 includes one projector 20, but the number of projectors 20 included in the display system 1 is not limited. Therefore, the number of projectors 20 controlled by the control device 10 is also not limited. For example, in the case of using the plurality of projectors 20, the projectors can receive and project different videos respectively to generate one video content. Furthermore, in the following description, an example will be described in which the projector 20 is used as a display device, and a video is projected on the screen 40 by the projector 20. However, the type of the display is not limited to the projector 20. The display included in the display system may be a display that displays a video.

### Configuration of Camera

FIG. 1C is a block diagram illustrating a configuration of the camera 30. As illustrated in FIG. 1C, the camera 30 includes an arithmetic circuit 31, an input device 32, an output device 33, a communication circuit 34, a storage 35, an optical mechanism 36, and the like. The arithmetic circuit 21, the input device 22, the output device 23, the communication circuit 24, and the storage 27 can be realized by specific means similar to the arithmetic circuit 11, the input device 12, the output device 13, the communication circuit 14, and the storage 15 described above with reference to FIG. 1A. The optical mechanism 36 includes a series of mechanisms related to acquisition of image data, and acquires the image data according to control from the arithmetic circuit 31. Specifically, the optical mechanism 36 includes an imaging element, an optical system element, an A/D converter, and the like.

### Configuration of User Terminal

The user terminal 50 is, for example, a terminal used by an operator who copes with a trouble of projection by the projector 20. FIG. 1D is a block diagram illustrating a configuration of the user terminal 50. As illustrated in FIG. 1D, the user terminal 50 is an information processing device including an arithmetic circuit 51, an input device 52, an output device 53, a communication circuit 54, a storage 55, and the like. For example, the user terminal 50 may be a personal computer, a smartphone, a tablet, or the like. The arithmetic circuit 51, the input device 52, the output device 53, the communication circuit 54, and the storage 55 can be realized by specific means similar to the arithmetic circuit 11, the input device 12, the output device 13, the communication circuit 14, and the storage 15 described above with reference to FIG. 1A.

The user who holds the user terminal 50 may exist at a place remote from the installation position of the projector 20. Therefore, the user can operate the projector 20 even in a case where the user is at a remote place from the installation position of the projector 20. Furthermore, even in a case where the user is at a remote location from the installation position of the projector 20, the user can grasp an environment change in which the projector is installed. Furthermore, when the user terminal 50 accesses the control device 10 via the network 60, processing may be executed via the cloud server 70. The cloud server 70 can store log data related to an operation from the user terminal 50.

### Processing in Control Device 10

Processing executed by the control device 10 will be specifically described. Specifically, the arithmetic circuit 11 performs the calibration processing at the timing of initial calibration and the timing of recalibration. More specifically, the arithmetic circuit 11 performs calibration processing of geometric distortion, calibration of positional deviation, calibration of color, calibration of focus, and/or calibration of color unevenness at the timings of initial calibration and recalibration. Here, each calibration greatly receives an environment change such as ambient light. Therefore, in each calibration, when an environment change is detected from the time of initial calibration to the time of recalibration, processing in consideration of the influence of the environment is executed.

The arithmetic circuit 11 acquires the first captured image in which the image is not displayed by the projector 20 from the camera 30 at the timing of initial calibration. The arithmetic circuit 11 acquires the second captured image in which the image is not displayed by the projector 20 from the camera 30 at the timing of recalibration after the initial calibration. The arithmetic circuit 11 compares the first captured image with the second captured image. As a result of the comparison, the arithmetic circuit 11 detects an area in which the difference in luminance is a predetermined value or more as an environment change.

When the environment change is detected, the arithmetic circuit 11 outputs a notification that the environment change has occurred. At this time, the arithmetic circuit 11 generates, as the notification, an image obtained by superimposing a marker indicating an area in which a difference in luminance from the first captured image is a predetermined value or more on the second captured image. For example, the arithmetic circuit 11 outputs the generated notification to the output device 13. Alternatively, the arithmetic circuit 11 outputs the generated notification to the user terminal 50. As a result, the user can grasp the environment change and take necessary measures.

The arithmetic circuit 11 causes the projector 20 to display the first pattern image when the environment change is not detected at the timing of recalibration of the image deviation. On the other hand, when no environment change is detected at the timing of recalibration of the image deviation, the arithmetic circuit 11 causes the projector 20 to display the second pattern image. The arithmetic circuit 11 acquires a captured image obtained by photographing the screen 40 on which either the first pattern image or the second pattern image is displayed. In addition, the arithmetic circuit 11 performs recalibration of the deviation of the image on the basis of the acquired captured image.

The arithmetic circuit 11 executes recalibration only when an environment change is not detected at the timing of calibration of color and/or focus recalibration. This is because the calibration of color and the calibration of focus are easily subject to a change in ambient light.

When the environment change is detected at the timing of color unevenness recalibration, the arithmetic circuit 11 generates a parameter for adjusting the color of the area where the environment change is detected according to the other area in order to calibrate the color unevenness. In addition, the arithmetic circuit 11 transmits the generated parameter to the projector 20.

Hereinafter, each calibration processing will be described with reference to a flowchart.

(Initial calibration: calibration of geometric distortion/calibration of positional deviation)

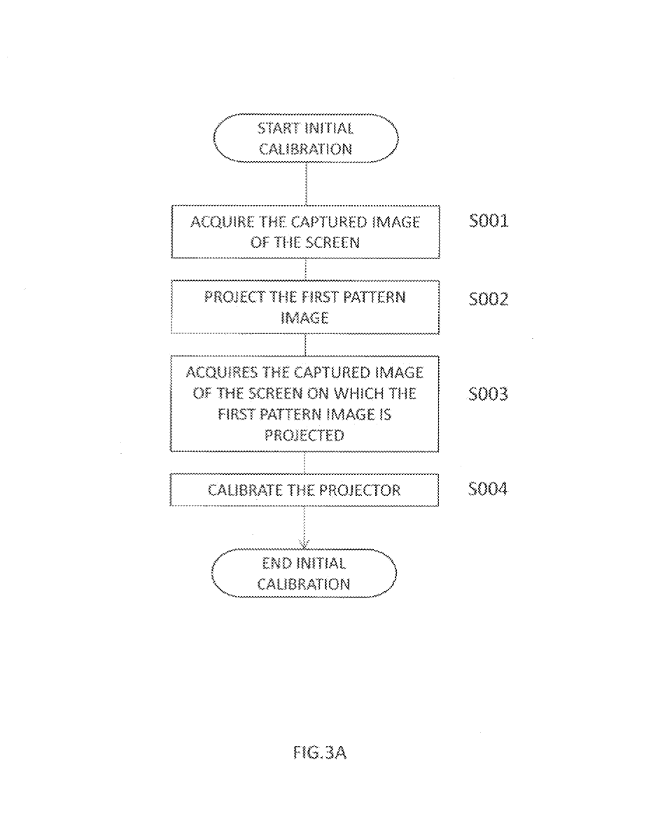

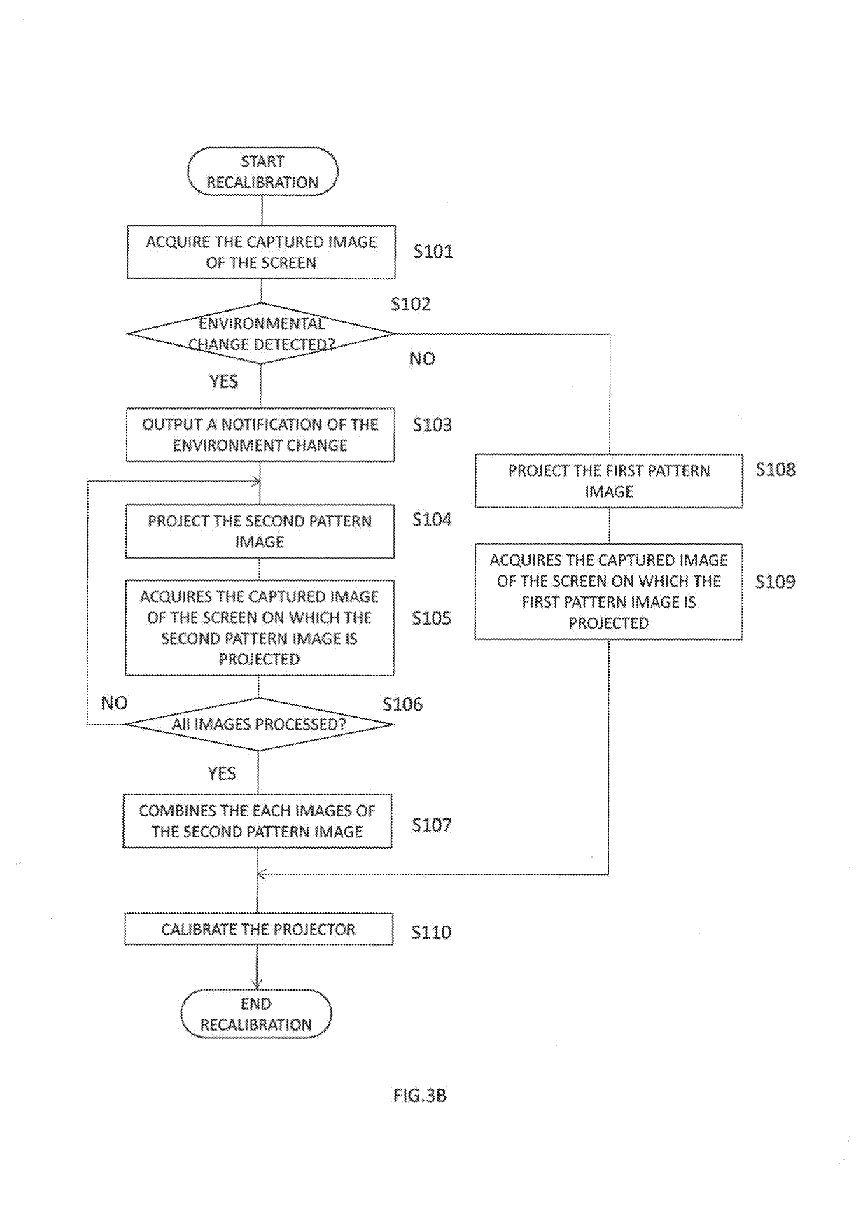

FIG. 3A is a flowchart for explaining calibration processing of geometric distortion and/or positional deviation executed by the arithmetic circuit 11 at the timing of initial calibration.

The arithmetic circuit 11 acquires, from the camera 30, the image of the screen 40 on which the video is not projected by the projector 20 as the first image (S001). Specifically, the arithmetic circuit 11 transmits a control signal for causing the camera 30 to capture an image in a state where no video is projected on the screen 40. In addition, the arithmetic circuit 11 receives the captured first captured image from the camera 30. At this time, the arithmetic circuit 11 stores the first captured image in the storage 15.

When the shooting of the first image is completed in step S001, the arithmetic circuit 11 transmits the first pattern image stored in the storage 15 to the projector 20 and causes the projector 20 to project the first pattern image onto the screen 40 (S002).

The arithmetic circuit 11 acquires the image of the screen 40 on which the first pattern image is projected by the projector 20 from the camera 30 as the captured image (S003). Specifically, the arithmetic circuit 11 transmits a control signal for causing the camera 30 to capture an image in a state where the first pattern image is projected on the screen 40. In addition, the arithmetic circuit 11 receives the captured image from the camera 30.

The arithmetic circuit 11 calibrates the calibration of the geometric distortion of the projector 20 using the captured image received in Step S003 (S004). As a result, the initial calibration of the calibration of the geometric distortion is completed.

### Recalibration: calibration of geometric distortion/calibration of positional deviation

FIG. 3B is a flowchart for explaining calibration processing of geometric distortion and/or positional deviation executed by the arithmetic circuit 11 at the timing of recalibration.

The arithmetic circuit 11 acquires, from the camera 30, the image of the screen 40 on which the video is not projected by the projector 20 as the second captured image (S101). Specifically, the arithmetic circuit 11 transmits a control signal for causing the camera 30 to capture an image in a state where no video is projected on the screen 40. In addition, the arithmetic circuit 11 receives the captured second captured image from the camera 30. At this time, the arithmetic circuit 11 stores the second captured image in the storage 15.

The arithmetic circuit 11 compares the first captured image acquired in step S003 of the initial calibration stored in the storage 15 with the second captured image acquired in step S101, and detects the presence or absence of the environment change based on the comparison result (S102).

When there is an environment change (YES in S102), the arithmetic circuit 11 generates and outputs a notification for notifying the user of the environment change (S103). For example, the arithmetic circuit 11 outputs a notification of an environment change to the output device 13. Furthermore, for example, the arithmetic circuit 11 may transmit a notification of an environment change to the user terminal 50. As a result, even in a case where the user is not aware of the environment change, the user can grasp the environment change and take necessary measures. Furthermore, by transmitting to the user terminal 50, the user can grasp an environment change even in a case where the user is not in an environment where the projector 20 projects a video.

In addition, the arithmetic circuit 11 transmits the second pattern image stored in the storage 15 to the projector 20, and causes the projector 20 to project the second pattern image onto the screen 40 (S104).

The arithmetic circuit 11 acquires the image of the screen 40 on which the second pattern image is projected by the projector 20 from the camera 30 as the captured image (S105). Specifically, the arithmetic circuit 11 transmits a control signal for causing the camera 30 to capture an image in a state where the second pattern image is projected on the screen 40. In addition, the arithmetic circuit 11 receives the captured image from the camera 30.

Here, as described above, the second pattern image includes a plurality of pattern images. Therefore, the arithmetic circuit 11 determines whether or not the acquisition of the captured images of all the pattern images included in the second pattern image has been completed (S106), and repeats the processing of steps S104 and S105 until the completion.

When the acquisition of the captured images of all the pattern images included in the second pattern image is completed (YES in S106), the arithmetic circuit 11 combines the images acquired in step S105 to obtain the feature point (S107).

When there is no environment change (NO in S102), the arithmetic circuit 11 transmits the first pattern image stored in the storage 15 to the projector 20, and causes the first pattern image to be projected onto the screen 40, as in the case of the initial calibration (S108).

The arithmetic circuit 11 acquires, from the camera 30, the image of the screen 40 on which the first pattern image is projected by the projector 20 as the captured image (S109).

The arithmetic circuit 11 calibrates the geometric distortion and/or the positional deviation of the projector 20 using the feature point obtained from the captured image acquired in Step S109 or the feature point obtained by combining the plurality of images in Step S107 (S110). As a result, the recalibration of the geometric distortion and/or the positional deviation is completed.

### Initial Calibration: Calibration of Color/Calibration of Focus

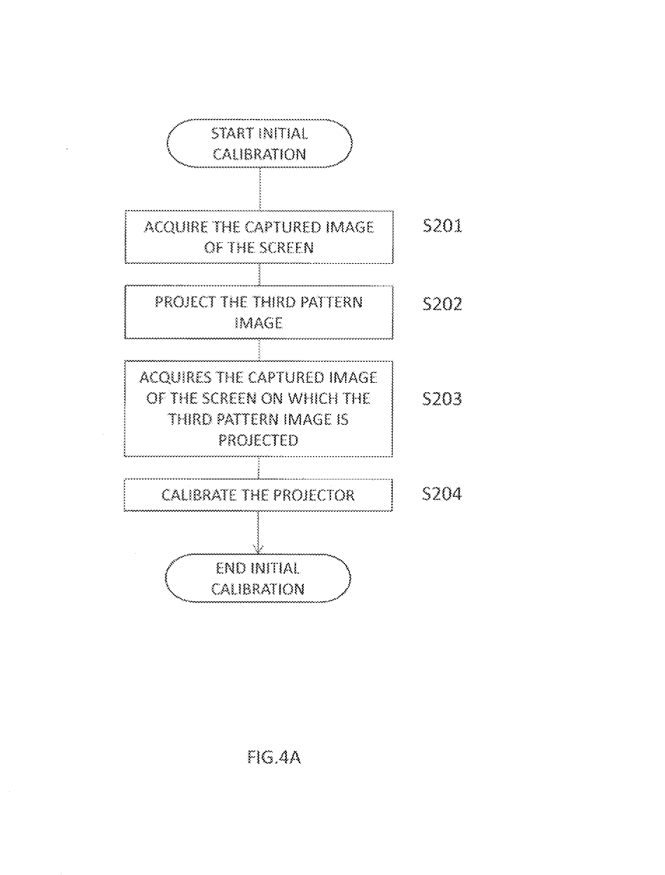

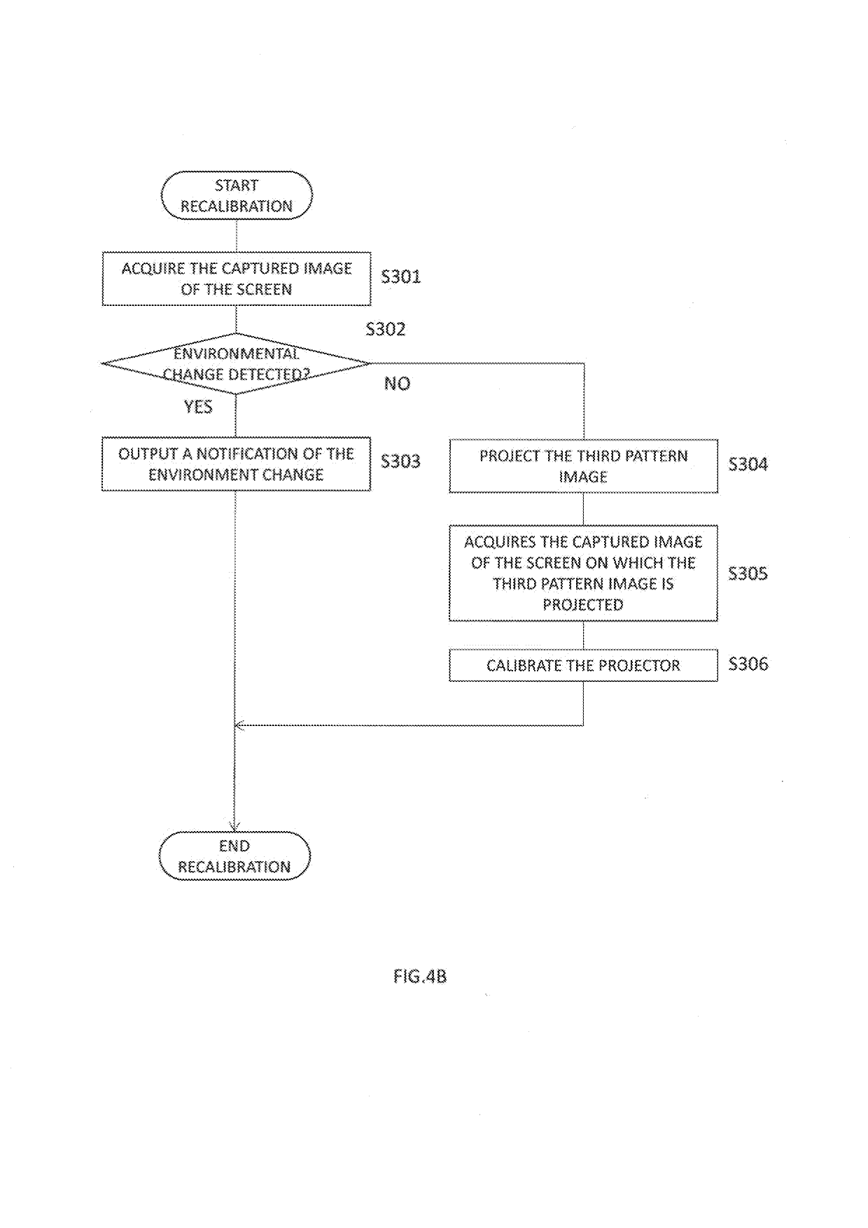

FIG. 4A is a flowchart illustrating calibration processing of color and/or focus executed by the arithmetic circuit 11 at the timing of initial calibration. A part of the processing described below may be common to the processing described above with reference to FIG. 3A. In addition, different processes may be executed in order, and simultaneously executable processes may be simultaneously executed.

The arithmetic circuit 11 acquires, from the camera 30, the image of the screen 40 on which the video is not projected by the projector 20 as the first captured image (S201). In addition, the arithmetic circuit 11 stores the first captured image in the storage 15. The processing may be common to step S001 in FIG. 3A.

When the shooting of the first image is completed in step S201, the arithmetic circuit 11 transmits the third pattern image stored in the storage 15 to the projector 20 and causes the third pattern image to be projected onto the screen 40 (S202).

The arithmetic circuit 11 acquires the image of the screen 40 on which the third pattern image is projected by the projector 20 from the camera 30 as the captured image (S203). Specifically, the arithmetic circuit 11 transmits a control signal for causing the camera 30 to capture an image in a state where the third pattern image is projected on the screen 40. In addition, the arithmetic circuit 11 receives the captured image from the camera 30.

The arithmetic circuit 11 calibrates the color and/or the focus of the projector 20 using the captured image acquired in step S203 (S204). As a result, the initial calibration of the calibration of color and/or the focus is completed.

### Recalibration: Calibration of Color/Calibration of Focus

FIG. 4B is a flowchart illustrating calibration processing of color and/or focus executed by the arithmetic circuit 11 at the timing of recalibration. A part of the processing described below may be common to the processing described above with reference to FIG. 3B. The different processes may be executed in order, and simultaneously executable processes may be simultaneously executed.

The arithmetic circuit 11 acquires, from the camera 30, the image of the screen 40 on which the video is not projected by the projector 20 as the second captured image (S301). The processing may be common to step S101 in FIG. 3B.

The arithmetic circuit 11 compares the first captured image acquired in the initial calibration stored in the storage 15 with the second captured image acquired in step S301, and detects the presence or absence of the environment change based on the comparison result (S302). The processing may be common to step S102 in FIG. 3B.

When there is an environment change (YES in S302), the arithmetic circuit 11 generates and outputs a notification for notifying the user of the environment change (S303). The processing may be common to step S103 in FIG. 3B.

When there is no environment change (NO in S302), the arithmetic circuit 11 transmits the third pattern image stored in the storage 15 to the projector 20, and causes the third pattern image to be projected onto the screen 40, as in the case of the initial calibration (S304).

The arithmetic circuit 11 acquires, from the camera 30, the image of the screen 40 on which the third pattern image is projected by the projector 20 as the captured image (S305).

The arithmetic circuit 11 calibrates the calibration of color and/or the focus of the projector 20 using the captured image acquired in step S305 (S306). Thus, the calibration of color and/or the focus recalibration is completed.

### Recalibration: Calibration of Color Unevenness

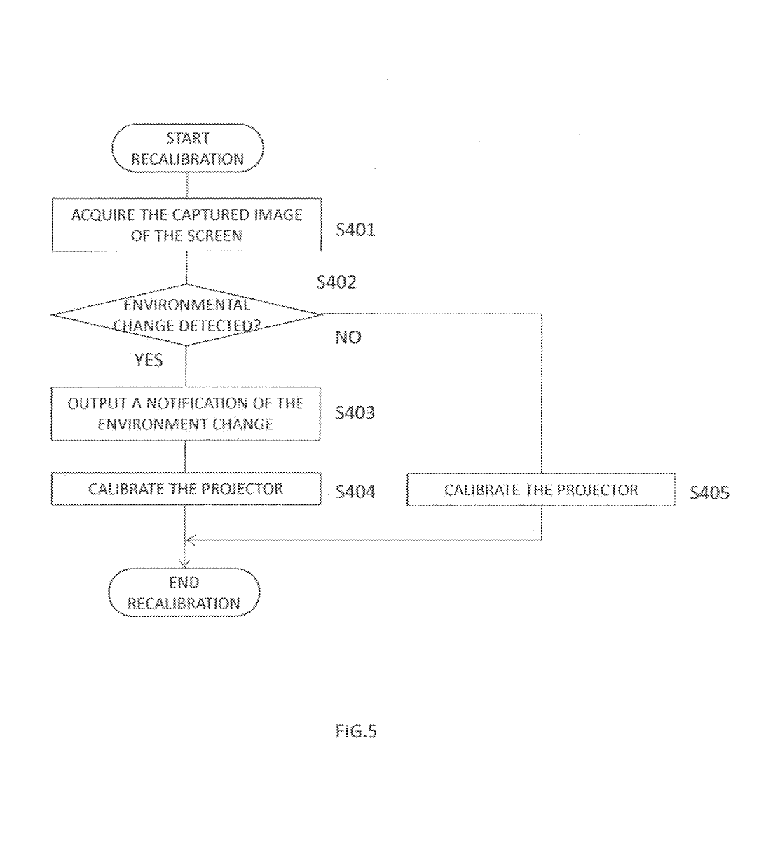

FIG. 5 is a flowchart for explaining calibration processing of color unevenness executed by the arithmetic circuit 11 at the timing of recalibration. Since the image of the screen 40 captured in the initial calibration is treated as a basis, calibration of color unevenness is not executed in the initial calibration. For example, the first captured image acquired in step S001 in FIG. 3A is used as the reference image.

The arithmetic circuit 11 acquires, from the camera 30, the image of the screen 40 on which the video is not projected by the projector 20 as the second captured image (S401). The processing may be common to step S101 in FIG. 3B.

The arithmetic circuit 11 compares the first captured image acquired in the initial calibration stored in the storage 15 with the second captured image acquired in step S101, and detects the presence or absence of the environment change based on the comparison result (S402). The processing may be common to step S102 in FIG. 3B.

When there is an environment change (YES in S402), the arithmetic circuit 11 generates and outputs a notification for notifying the user of the environment change (S403). The processing may be common to step S103 in FIG. 3B.

The arithmetic circuit 11 calibrates the color unevenness of the projector (S404). Thus, the recalibration of the color unevenness is completed.

When there is no environment change (NO in S402), the arithmetic circuit 11 calibrates the color unevenness of the projector (S404). Thus, the recalibration of the color unevenness is completed.

At the time of recalibration, the display system 1 according to the present disclosure determines a procedure of processing according to presence or absence of an environment change. As a result, it is possible to realize appropriate recalibration of the projector 20 according to the environment change.

### First Modification

In the display system 1 according to First Modification of the first exemplary embodiment, a reference point for positional deviation detection is attached to the screen 40 in advance. Other calibration is the same as the display system 1 described above with reference to FIG. 1A. Therefore, the display system 1 according to First Modification will be described with reference to FIG. 1A.

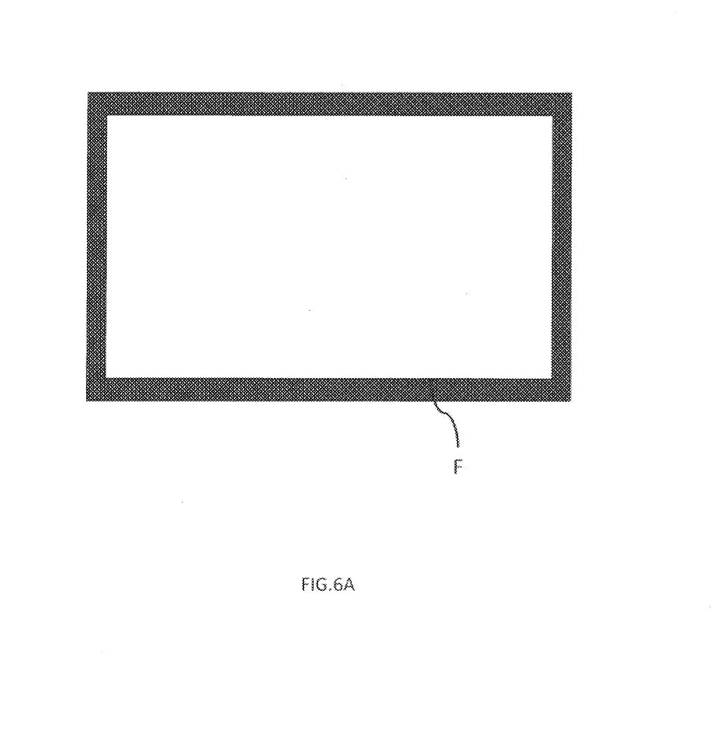

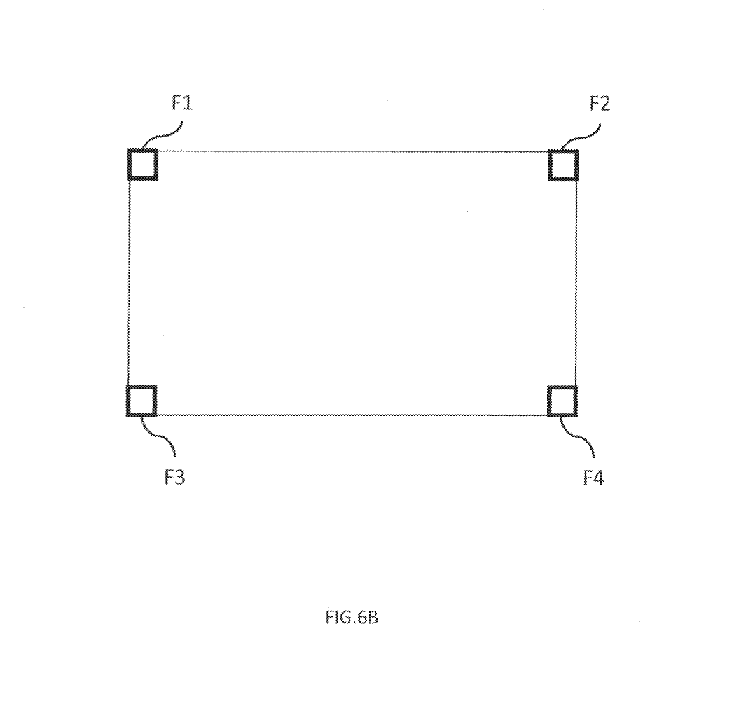

For example, FIG. 6A is an example of an outer frame including a reference point. An example illustrated in FIG. 6A is rectangular outer frame F that highlights the boundary of the screen 40. For example, each of the squares inside the outer frame F may be used as the reference point. The arithmetic circuit 11 detects the reference point specified by outer frame F in the initial calibration. In addition, the arithmetic circuit 11 stores information of the detected reference point in the storage 15. In the recalibration, the arithmetic circuit 11 can detect the presence or absence of the positional deviation by comparing the information on the reference point stored in the storage 15 with the information on the newly detected reference point.

FIG. 6B is another example of the reference point. An example illustrated in FIG. 6B is marks F1 to F4 indicating reference points respectively set at four corners of the rectangle of the screen 40. For example, each of the marks F1 to F4 may be a light emitter such as an LED. The arithmetic circuit 11 detects a plurality of reference points specified by the marks F1 to F4 in the initial calibration. In addition, the arithmetic circuit 11 stores information of the plurality of detected reference points in the storage 15. In the recalibration, the arithmetic circuit 11 can detect the presence or absence of the positional deviation by comparing the information on the reference point stored in the storage 15 with the information on the newly detected reference point.

### Initial Calibration

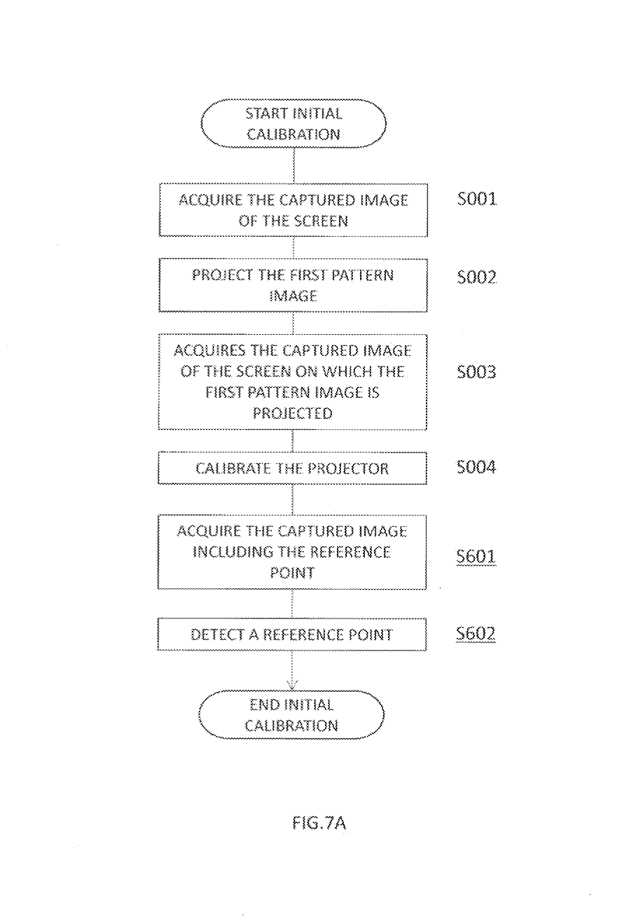

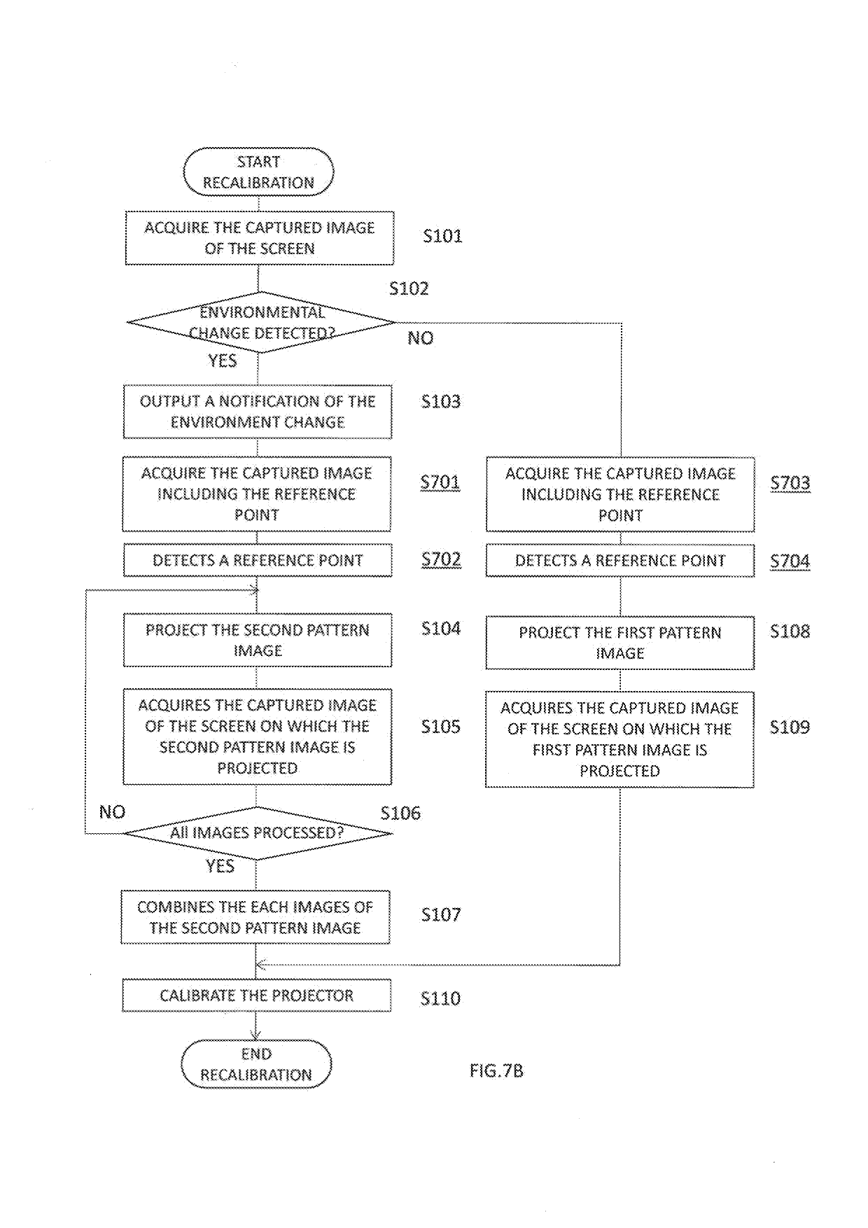

With reference to FIG. 7A, calibration processing of positional deviation executed at the timing of initial calibration in the arithmetic circuit 11 of the control device 10 according to First Modification will be described. In FIG. 7A, the same processes as those in FIG. 3A are denoted by the same reference numerals, and description thereof is omitted. Note that the numbers of different processes are underlined.

After calibrating the projector 20 in step S004, the arithmetic circuit 11 acquires the captured image including the reference point (S601). If the reference point is the marks F1 to F4 or the like of the light emitting body such as the LED illustrated in FIG. 6B, the arithmetic circuit 11 causes the marks F1 to F4 to emit light when capturing an image. When the captured image acquired in step S001 includes the reference point, the arithmetic circuit 11 can omit the processing in step S601. For example, when the captured image acquired in step S001 includes the outer frame including the non-light emitting reference point as illustrated in FIG. 6A, the arithmetic circuit 11 can omit the processing in step S601.

The arithmetic circuit 11 detects a reference point from the captured image acquired in step S601, and stores information of the reference point in the storage 15 (S602).

In this way, by storing the positions of the reference points, the positions can be used in recalibration.

### Recalibration

With reference to FIG. 7B, calibration processing of positional deviation executed at the timing of recalibration in the arithmetic circuit 11 of the control device according to the modification will be described. In FIG. 7B, the same processes as those in FIG. 3B are denoted by the same reference numerals, and the description thereof will be omitted. Note that the numbers of different processes are underlined.

When the environment change is not detected (YES in S102), the arithmetic circuit 11 outputs the notification to the user in step S103, and then, acquires the captured image including the reference point (S701).

The arithmetic circuit 11 detects a reference point from the captured image acquired in step S701 (S702).

Alternatively, when no environment change is detected (NO in S102), the arithmetic circuit 11 acquires the captured image including the reference point before projecting the first pattern image (S703). If the reference points are the marks F1 to F4 of the light emitting body such as the LED illustrated in FIG. 6B, the arithmetic circuit 11 causes the marks F1 to F4 to emit light when capturing the captured image acquired in step S701 or S703. When the captured image acquired in step S101 includes the outer frame including the non-light emitting reference point as illustrated in FIG. 6A, the arithmetic circuit 11 can omit the processing in step S701 or S703.

The arithmetic circuit 11 detects a reference point from the captured image acquired in step S703 (S704).

In the calibration of the positional deviation of the projector in step S110, the arithmetic circuit 11 uses the information of the reference point detected in step S702 or S704.

The display system 1 according to First Modification can realize the positional deviation calibration with high accuracy by detecting the position of the screen using the reference point provided on the screen 40.

### Second Modification

A display system according to Second Modification of the first embodiment has the same configuration as the display system 1 described above with reference to FIG. 1A. Therefore, description will be made with reference to FIG. 1A. In addition to the display system 1 according to the first embodiment, the display system 1 according to Second Modification has a function of selecting a feature point of a pattern image. In addition, the display system 1 according to Second Modification has a function of notifying that the positional deviation has occurred to such an extent that the positional deviation cannot be handled by the positional deviation calibration.

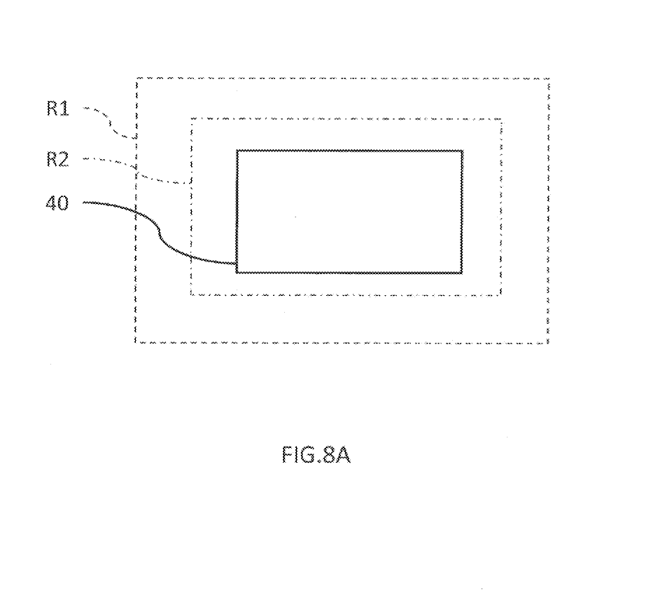

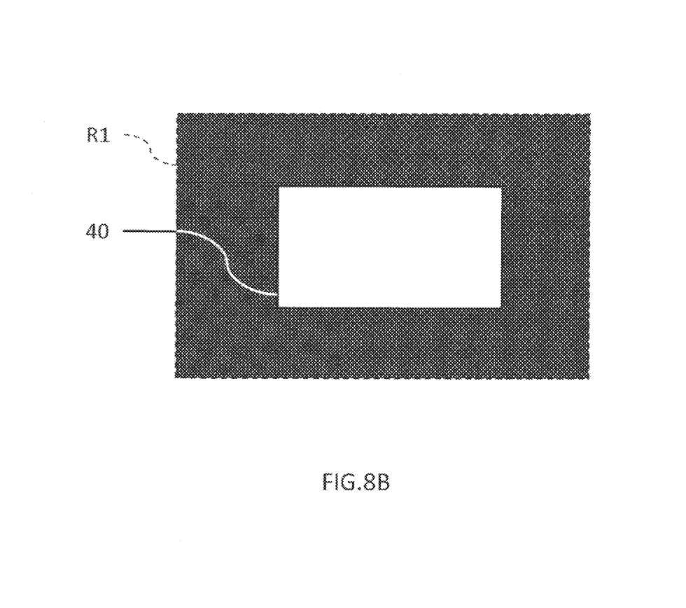

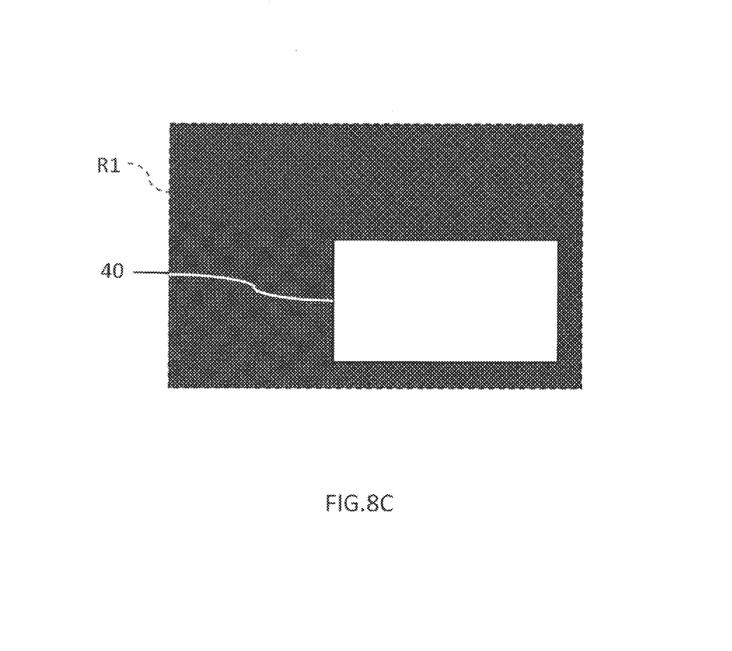

FIG. 8A illustrates a relationship among the screen 40 (solid line), the projectable range R1 of the projector 20 (broken line), and capturable range R2 of the camera 30 (dashed-dotted line). In general, as illustrated in FIG. 8A, the projector 20 is set such that the projectable range R1 of the projector 20 is wider than the screen 40.

For example, it is assumed that the projector 20 projects a pattern image over the entire projectable range R1. Since the camera 30 cannot photograph the pattern image projected outside the capturable range R2, it can photograph only a part of the pattern image. Hitherto, in a case where the captured image includes only a part of the pattern image, the control device 10 interpolates the feature point not shown in the captured image. However, when the interpolation processing is used, it may be difficult to perform accurate positional deviation calibration. In addition, the outside of the screen 40 is formed of a material different from that of the screen 40, and may not be suitable for projection of a video due to unevenness, a color different from that of the screen 40, or the like. Therefore, when positional deviation calibration is performed without distinguishing between the feature point of the pattern image in the range projected on the inner side of the capturable range R2 outside the screen 40 and the feature point of the pattern image in the range projected on the screen 40, it may be difficult to perform accurate calibration. Therefore, the control device 10 according to Second Modification executes the positional deviation calibration using only the feature points in the selected range.

Further, at the time of initial calibration, as illustrated in FIG. 8B, the control device 10 performs control such that the video is not projected out of the screen 40, but the outside of the screen 40 is projected in black, and the desired content video is projected only in the screen 40. When the positional deviation of the projector 20 occurs due to a change with time or the like, the projector 20 adjusts the range in which the content video is projected with respect to the projectable range R1 in accordance with the positional deviation as illustrated in FIG. 8C. However, the projector 20 cannot detect that the projectable range R1 is approaching the limit of the screen 40. As illustrated in FIG. 8C, the control device 10 according to Second Modification detects and notifies occurrence of positional deviation in a range that cannot be handled by positional deviation calibration.

### Initial Calibration

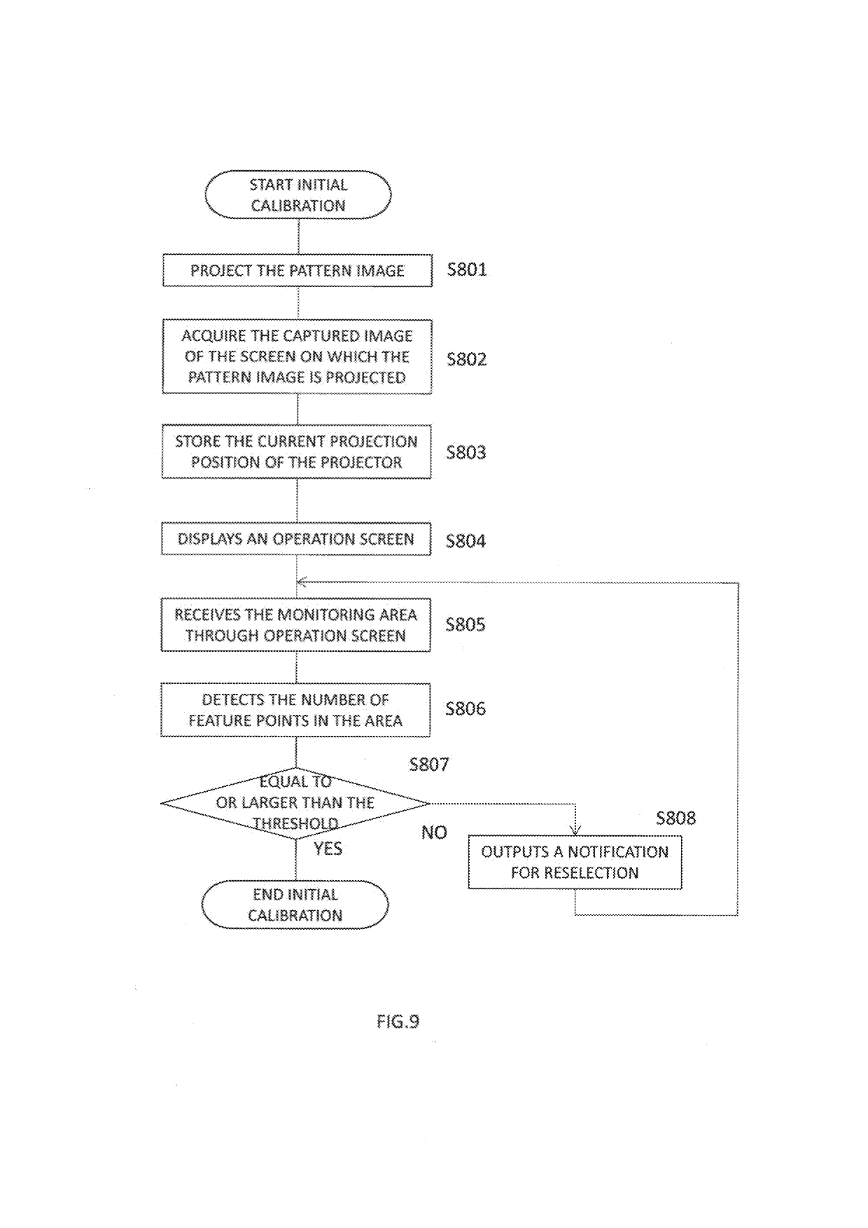

With reference to FIG. 9, calibration processing of positional deviation executed at the timing of initial calibration in the arithmetic circuit 11 of the control device 10 according to Second Modification will be described.

The arithmetic circuit 21 transmits the pattern image stored in the storage 15 to the projector 20 and causes the pattern image to be projected onto the screen 40 (S801). Since it is the time of initial calibration, the pattern image projected in step S801 is the first pattern image.

The arithmetic circuit 11 acquires the captured image of the screen 40 on which the pattern image is projected by the projector 20 from the camera 30, and stores the captured image in the storage 15 (S802).

The arithmetic circuit 11 stores the current projection position of the projector 20 by using the captured image acquired in step S802 (S803). At this time, the arithmetic circuit 11 can obtain the position of the projector 20 from the position of the screen 40 in the captured image and the position of the feature point projected on the screen 40.

The arithmetic circuit 11 displays an operation screen on the output device 13 (S804). The operation screen is used for an operation of selecting a range of feature points used for positional deviation calibration.

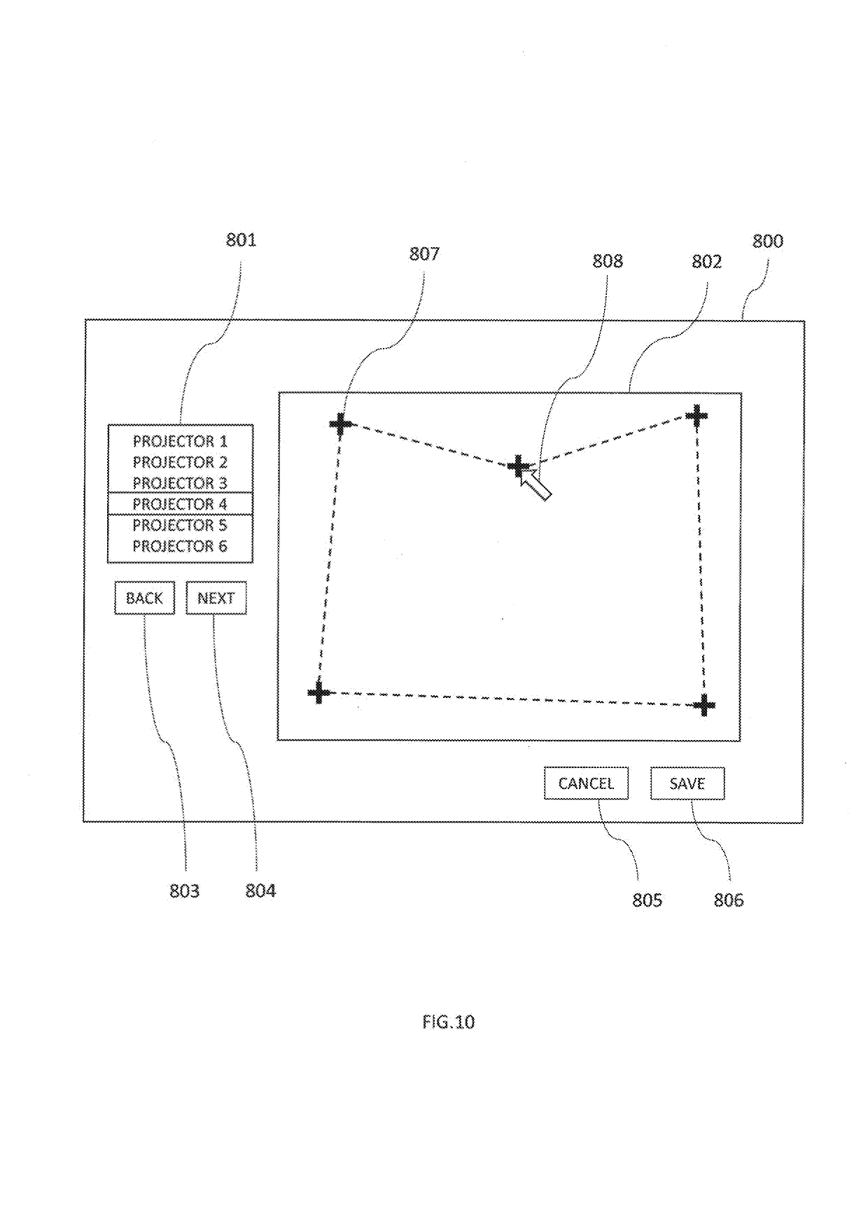

FIG. 10 illustrates an example of the operation screen 800. The operation screen 800 includes a projector selection unit 801, a range selection unit 802, a selection button 803, 804, and an operation button 805, 806. The projector selection unit 801 displays identification information of a projector selected by operating the selection button 803, 804. The range selection unit 802 displays an image to be used for selecting a range of feature points to be used for positional deviation calibration. In the range selection unit 802, the currently designated range is indicated by a plurality of marks 807. At this time, the control device 10 causes the projector 20 to project a position corresponding to each mark 807. Therefore, the user operates the pointer 808 via the input device 12 while confirming the position of the mark actually projected by the projector 20. Then, the range of the feature point is set such that the position of each mark 807 falls within the screen 40. When the operation button 805 is selected, the arithmetic circuit 11 cancels the range designated by each mark 807. When the operation button 806 is selected, the arithmetic circuit 11 determines the range designated by each mark 807.

The arithmetic circuit 11 receives the range designated through operation screen 800 as the monitoring area (S805). In addition, the arithmetic circuit 11 stores the monitoring area in the storage 15.

The arithmetic circuit 11 detects the number of feature points in the monitoring area received in step S805 (S806).

When the number of feature points in the monitoring area is not equal to or larger than the threshold (NO in S807), the arithmetic circuit 11 outputs a notification for performing selection again (S808). This is because, for example, when the number of feature points included in the monitoring area is small, the arithmetic circuit 11 cannot perform accurate positional deviation calibration. When the user who has confirmed the notification that needs to be selected again cannot respond on the operation screen 800, the user can also adjust the position of the projector 20 and the position of the camera 30.

### Recalibration

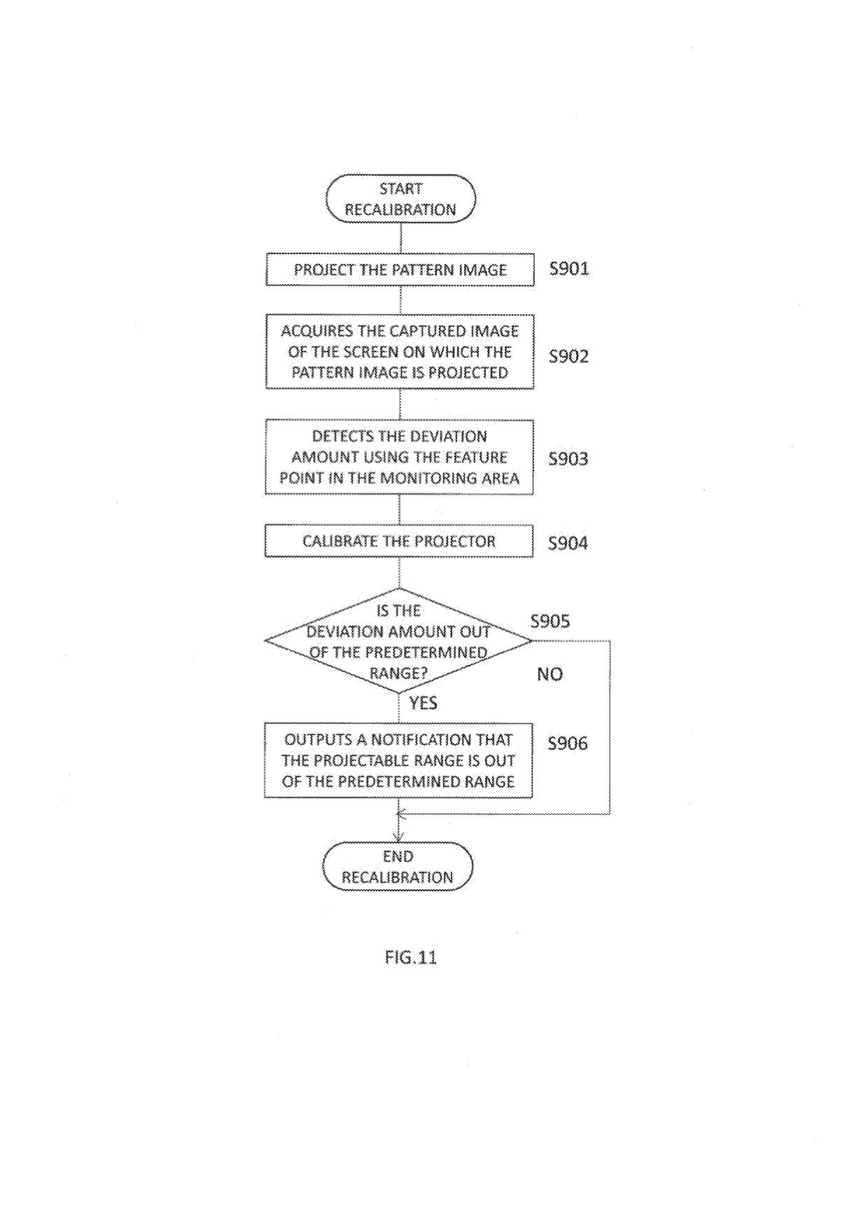

With reference to FIG. 11, calibration processing of positional deviation executed at the timing of recalibration in the arithmetic circuit 11 of the control device according to Second Modification will be described.

The arithmetic circuit 11 transmits the pattern image stored in the storage 15 to the projector 20 and causes the pattern image to be projected onto the screen 40 (S901). Note that since it is the time of recalibration, when the pattern image is projected, a series of processes for detecting the occurrence of environment change described above using steps S101 to S110 in FIG. 3B is executed. However, in the flowchart of FIG. 11, a series of processes for detecting the occurrence of an environment change is omitted. In step S901, when an environment change is detected, the second pattern image is projected, and when no environment change is detected, the first pattern image is projected.

The arithmetic circuit 11 acquires, from the camera 30, the captured image of the screen 40 on which the pattern image is projected by the projector 20 (S902).

The arithmetic circuit 11 detects the deviation amount using the feature point in the monitoring area set in step S805 of the initial calibration, among the captured image acquired in step S802 of the initial calibration and the captured image acquired in step S902 stored in the storage 15 (S903).

The arithmetic circuit 11 calibrates the positional deviation of the projector 20 using the deviation amount detected in step S903 (S904).

The arithmetic circuit 11 determines whether the projectable range of the projector is out of the predetermined range determined with respect to the screen 40 by using the deviation amount detected in step S903 (S905).

When it is not out of the predetermined range (NO in S905), the arithmetic circuit 11 ends the recalibration processing.

When the projectable range is out of the predetermined range (YES in S905), the arithmetic circuit 11 outputs a notification that the projectable range is out of the predetermined range, and ends the recalibration processing (S906).

The display system 1 according to Second Modification can select a feature point to be used from a pattern image in accordance with projection by the projector 20. In addition, the display system 1 according to Second Modification can output the notification in which the positional deviation that cannot be handled by the positional deviation calibration has occurred.

### Outline of Embodiment

(1) The present disclosure relates to a calibration method of a display, executed by a display system, the display system including a display, an imaging device, and an information processing device, wherein the display configured to display an image, wherein the imaging device configured to capture a range in which the image is displayed by the display, wherein the information processing device configured to calibrate the display on the basis of a captured image captured by the imaging device and having an arithmetic circuit,

the calibration method comprising, by the arithmetic circuit, may:

acquire a first captured image in a state in which no image is displayed by the display from the imaging device at the timing of initial calibration;

acquire a second captured image in a state in which no image is displayed by the display from the imaging device at the timing of recalibration after the initial calibration;

compare the first captured image with the second captured image;

detect, as a result of the comparison, an area where a difference in luminance is a predetermined value or more, with an influence of an environment change; and

when the environment change is detected, output a notification that the environment change has occurred.

As a result, when the display is recalibrated, the procedure of the processing can be determined according to the presence or absence of the environment change.

(2) In the calibration method of (1), the arithmetic circuit may generate, as the notification, an image obtained by superimposing a marker indicating an area in which a difference in luminance from the first captured image is a predetermined value or more on the second captured image.

As a result, it is possible to cause the user to grasp the area where the environment change has occurred.

(3) In the calibration method of (1) or (2), the arithmetic circuit may:

transmit and display a first pattern image representing, in a single image, a plurality of feature points on the display when an environment change is not detected at the timing of recalibration of a positional deviation of the image;

transmit and display a second pattern image representing, in a plurality of images in a different representation from the first pattern image, the plurality of feature points on the display when an environment change is detected at the timing of recalibration of a positional deviation of the image;

acquire, from the imaging device, a captured image obtained by capturing one of the first pattern image and the second pattern image displayed on the display; and

calibrate the positional deviation of the image on the basis of a feature point obtained from the captured image.

As a result, it is possible to recalibrate the positional deviation according to the environment change.

(4) In the calibration methods of (1) to (3), the first pattern image may be a single image in which a plurality of feature points are represented in a plurality of colors, and

the second pattern image may be a set of images including a plurality of images in which feature points are represented by binary values.

As a result, even when the environment change occurs, the positional deviation calibration can be performed using the corresponding second pattern image.

(5) In the calibration method of (1) to (4), the arithmetic circuit may:

when an environment change is detected, generate a parameter for adjusting a color of an area according to other areas; and

transmit the parameter to the display.

As a result, an environment change can be calibrated.

(6) In the calibration methods of (1) to (5), the information processing device may be capable of accessing a user terminal, and

the output of the notification may be transmission to the user terminal.

As a result, the user can comprehend the environment change even when the user is at a remote location.

(7) In the calibration methods of (1) to (6), further comprising, by the arithmetic circuit, may:

transmit and display a pattern image including a plurality of feature points on a display at the timing of calibration of positional deviation of an image, wherein the display is included in the information possessing device;

acquire, from the imaging device, a captured image obtained by capturing a pattern image displayed on the display;

display the captured image on the display;

receive selection of an area including at least one feature point from the plurality of feature points included in the pattern image displayed on the display; and

set the at least one feature point of the selected area as feature points for calibration of positional deviation of the image.

As a result, it is possible to select and use a useful positional deviation feature point.

(8) In the calibration methods of (1) to (7), the arithmetic circuit may output a notification that the size of the selected area is small when the number of the at least one feature point in the selected area is a predetermined ratio or more with respect to the number of the plurality of feature points.

As a result, it is possible to output the notification when the useful positional deviation cannot be detected.

(9) In the calibration methods of (1) to (8), further comprising,

by the arithmetic circuit, may:

transmit and display a pattern image including a plurality of feature points on the display at the timing of calibration of positional deviation of an image;

acquire, from the imaging device, a captured image obtained by capturing a pattern image displayed on the display;

display the captured image on the display;

receive selection of an area including at least one feature point from the plurality of feature points included in the pattern image displayed on the display; and

determine the position of the pattern image using the remaining feature points excluding the feature point in the selected area.

As a result, it is possible to select and use a useful positional deviation feature point.

(10) A computer program according to the present disclosure causes an information processing device to execute the calibration methods of (1) to (9).

As a result, when the display is recalibrated, the procedure of the processing can be determined according to the presence or absence of the environment change.

(11) The present disclosure relates to a display system including: a display, an imaging device, and an information processing device, wherein the display configured to display an image, wherein imaging device configured to captures a range in which the image is displayed by the display, wherein the information processing device configured to calibrates the display on the basis of a captured image captured by the imaging device and having and arithmetic circuit,

the arithmetic circuit may:

acquire a first captured image in a state in which no image is displayed by the display from the imaging device at the timing of initial calibration;

acquire a second captured image in a state in which no image is displayed by the display from the imaging device at the timing of recalibration after the initial calibration;

compare the first captured image with the second captured image;

detect, as a result of the comparison, an area where a difference in luminance is a predetermined value or more, with an influence of an environment change; and

when the environment change is detected, output a notification that the environment change has occurred.

As a result, when the display is recalibrated, the procedure of the processing can be determined according to the presence or absence of the environment change.

The display system, the calibration method, and the computer program according to all claims of the present disclosure are realized by cooperation with hardware resources such as a processor and a memory, and a computer program.

The designation method, the control device 10, and computer program of the present disclosure are useful for adjustment of a display system configured to combine videos displayed by a plurality of displays into one video.

What is claimed is:

1. A calibration method of a display, executed by a display system, the display system including a display, an imaging device, and an information processing device, wherein the display configured to display an image, wherein the imaging device configured to capture a range in which the image is displayed by the display, wherein the information processing device configured to calibrate the display on the basis of a captured image captured by the imaging device and having an arithmetic circuit,
the calibration method comprising, by the arithmetic circuit:
acquiring a first captured image in a state in which no image is displayed by the display from the imaging device at the timing of initial calibration;
acquiring a second captured image in a state in which no image is displayed by the display from the imaging device at the timing of recalibration after the initial calibration;
comparing the first captured image with the second captured image;
detecting, as a result of the comparison, an area where a difference in luminance is a predetermined value or more, with an influence of an environment change; and
when the environment change is detected, outputting a notification that the environment change has occurred.

2. The calibration method according to claim 1, wherein the arithmetic circuit generates, as the notification, an image obtained by superimposing a marker indicating an area in which a difference in luminance from the first captured image is a predetermined value or more on the second captured image.

3. The calibration method according to claim 1, wherein the arithmetic circuit:
transmits and displays a first pattern image representing, in a single image, a plurality of feature points on the display when an environment change is not detected at the timing of recalibration of a positional deviation of the image;
transmits and displays a second pattern image representing, in a plurality of images in a different representation from the first pattern image, the plurality of feature points on the display when an environment change is detected at the timing of recalibration of a positional deviation of the image;
acquires, from the imaging device, a captured image obtained by capturing one of the first pattern image and the second pattern image displayed on the display; and
calibrates the positional deviation of the image on the basis of a feature point obtained from the captured image.

4. The calibration method according to claim 3, wherein the first pattern image is a single image in which a plurality of feature points are represented in a plurality of colors, and
the second pattern image is a set of images including a plurality of images in which feature points are represented by binary values.

5. The calibration method according to claim 1, wherein the arithmetic circuit:
when an environment change is detected, generates a parameter for adjusting a color of an area according to other areas; and
transmits the parameter to the display.

6. The calibration method according to claim 1, wherein the information processing device is capable of accessing a user terminal, and
the output of the notification is transmission to the user terminal.

7. The calibration method according to claim 2, wherein the information processing device is capable of accessing a user terminal, and
the output of the notification is transmission to the user terminal.

8. The calibration method according to claim 3, wherein the information processing device is capable of accessing a user terminal, and
the output of the notification is transmission to the user terminal.

9. The calibration method according to claim 4, wherein the information processing device is capable of accessing a user terminal, and
the output of the notification is transmission to the user terminal.

10. The calibration method according to claim 1, further comprising, by the arithmetic circuit:
transmitting and displaying a pattern image including a plurality of feature points on a display at the timing of calibration of positional deviation of an image, wherein the display is included in the information possessing device;
acquiring, from the imaging device, a captured image obtained by capturing a pattern image displayed on the display;
displaying the captured image on the display;
receiving selection of an area including at least one feature point from the plurality of feature points included in the pattern image displayed on the display; and
setting the at least one feature point of the selected area as feature points for calibration of positional deviation of the image.

11. The calibration method according to claim 10, wherein the arithmetic circuit outputs a notification that the size of the selected area is small when the number of the at least one feature point in the selected area is a predetermined ratio or more with respect to the number of the plurality of feature points.

12. The calibration method according to claim 1, further comprising, by the arithmetic circuit:
transmitting and displaying a pattern image including a plurality of feature points on the display at the timing of calibration of positional deviation of an image;
acquiring, from the imaging device, a captured image obtained by capturing a pattern image displayed on the display;
displaying the captured image on the display;
receiving selection of an area including at least one feature point from the plurality of feature points included in the pattern image displayed on the display; and
determining the position of the pattern image using the remaining feature points excluding the feature point in the selected area.

13. A non-transitory computer-readable recording medium storing a computer program, wherein the information processing device is connected to a display and an imaging device, wherein the display configured to display an image, wherein the imaging device configured to capture a range in which the image is displayed by the display, wherein the computer program causing the information processing device to execute:
acquiring a first captured image in a state in which no image is displayed by the display from the imaging device at the timing of initial calibration;
acquiring a second captured image in a state in which no image is displayed by the display from the imaging device at the timing of recalibration after the initial calibration;
comparing the first captured image with the second captured image;
detecting, as a result of the comparison, an area where a difference in luminance is a predetermined value or more, with an influence of an environment change; and
when the environment change is detected, outputting a notification that the environment change has occurred.

14. A display system comprising: a display, an imaging device, and an information processing device, wherein the display displays an image, wherein the imaging device captures a range in which the image is displayed by the display, wherein the information processing device calibrate the display on the basis of a captured image captured by the imaging device and having and arithmetic circuit,
the arithmetic circuit:
acquires a first captured image in a state in which no image is displayed by the display from the imaging device at the timing of initial calibration;
acquires a second captured image in a state in which no image is displayed by the display from the imaging device at the timing of recalibration after the initial calibration;
compares the first captured image with the second captured image;
detects, as a result of the comparison, an area where a difference in luminance is a predetermined value or more, with an influence of an environment change; and
when the environment change is detected, outputs a notification that the environment change has occurred.
